(19) United States
(12) Patent Application Publication
(10) Pub. No.: US 2023/0362302 A1
(43) Pub. Date: Nov. 9, 2023

(54) MESSAGE-BASED NOTIFICATION THAT A CALLED PARTY IS BUSY

(71) Applicant: Microsoft Technology Licensing, LLC, Redmond, WA (US)

(72) Inventors: Tapas Kumar SARKAR, Hyderabad (IN); Oinam Ibochouba SINGH, Bangalore (IN); Naveenraj C G, Cherthala (IN)

(21) Appl. No.: 17/740,133

(22) Filed: May 9, 2022

(51) Int. Cl. H04W 4/14; H04M 3/48

(52) U.S. Cl. CPC H04M 3/48; H04W 4/14

(57) ABSTRACT

A VoLTE (Voice over Long-Term Evolution) network comprising 4G (4^{th} generation) LTE and IMS (Internet Protocol Multimedia Subsystem) networks includes an application server configured to provide message-based notifications to user equipment of a calling party when a previously busy called party is free to accept a new voice call. In an illustrative embodiment, a CCBS (Completion of Communications to Busy Subscriber) service signalling flow described by 3GPP (3^{rd} Generation Partnership Project) technical specification TS 24.642 is modified to replace an automated CCBS recall (i.e., call back) to the calling party with a notification comprising an SMS (Short Message Service) message. The SMS notification is sent using Session Initiation Protocol (SIP) proxy servers implementing call session control functions (CSCF) in an IMS core that interoperate with an IP Short-Message-Gateway (IP-SM-GW) between the LTE and IMS networks that appears to the IMS core as another application server.

### BACKGROUND

Voice over Long-Term Evolution (Voice over LTE or VoLTE) is the practice of packetizing voice over the Internet Protocol (VoIP) and transporting both the signalling and media components over a 4G (4^{th} Generation) LTE packet switched (PS) data path. This is in contrast to delivering voice using conventional circuit switch (CS) methodologies, which require 4G handsets - referred to as user equipment (UE) -to employ secondary 3G (3^{rd} Generation) radio and network operators to continue supporting this inefficient access infrastructure and licensed spectrum. The GSMA Global System for Mobile Communications Association (GSMA) Permanent Reference Document (PRD) IR.92 describes the application of the Internet Protocol Multimedia Subsystem (IMS) for the transport of voice and short message service (SMS) traffic (SM-over-IP). IR.92 identifies a minimum subset of mandatory 3GPP (3rd Generation Partnership Project) standard features that UE are required to implement in order to guarantee interoperability in all-packet infrastructures. Along with defining basic IMS capabilities and the requirements of the Radio Access Network (RAN) and the Evolved Packet Core (EPC), IR.92 identifies mandatory supplementary services which must be supported by the signalling core and suitable application server (AS).

### SUMMARY

A VoLTE network comprising 4G LTE and IMS networks includes an AS configured to provide message-based notifications to UE of a calling party when a previously busy called party is free to accept a new voice call. In an illustrative embodiment, a CCBS (Completion of Communications to Busy Subscriber) service signalling flow described by 3GPP technical specification TS 24.642 is modified to replace an automated CCBS recall (i.e., call back) to the calling party with a notification comprising an SMS message. The SMS notification is composed in the AS and sent using Session Initiation Protocol (SIP) proxy servers implementing call session control functions (CSCF) in an IMS core that interoperate with an IP (Internet Protocol) Short-Message-Gateway (IP-SM-GW) between the LTE and IMS networks that appears to the IMS core as another AS. The SMS-based notifications can be queued in cases in which multiple calling parties attempt to reach the called party and sent using a FIFO (first in, first out) or other prioritization methodology.

The present SMS-based notifications provide technical improvements in network resource utilization by reducing the consumption of resources in the access and core networks needed to establish signalling radio bearers and SIP registration for VoLTE calls. By sending an SMS-based notification when the previously called party becomes free, a scenario is avoided in which a calling party makes multiple attempts to reach a called party who continues to be busy on another call. The need for the network to make multiple call backs to CCBS service subscribers is obviated by the SMS-based notifications. The battery lifetime of a UE may also be advantageously optimized by enabling the UE to enter DRX (Discontinuous Reception) or sleep mode rather than remain awake to monitor the CCBS signalling from the network.

The user experience of the calling party is improved as the SMS-based notification lets the calling party decide when to place the voice call back rather than be automatically connected by the CCBS service as soon as the previously called party is free. User preferences may also be provided to users to control the SMS-based notification process. For example, notifications that the user is free to receive calls can be reviewed prior to sending, disabled, enabled for only known contacts, or enabled for selected contacts (e.g., contacts in a particular group in the user’s address book). The SMS-based notification may include links or controls to enable the calling party to initiate the VoLTE call back directly from the SMS message as a single-touch call back feature.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from a reading of the following Detailed Description and a review of the associated drawings.

### DESCRIPTION OF THE DRAWINGS

FIG. 1 shows an illustrative telecommunications environment in which user equipment (UE) having telephony capabilities communicate over network infrastructure that may include multiple communications networks;

FIG. 2 shows an illustrative use scenario in which multiple callers attempt to call a user who is busy with another voice call;

FIGS. 3 and 4 show illustrative use scenarios for receiving CCBS recalls for calling parties subscribing to a CCBS (Completion of Communications to Busy Subscriber) service described by 3GPP (3rd Generation Partnership Project) technical specification TS 24.642;

FIG. 5 shows an illustrative use scenario using the present principles in which an SMS (Short Message Service) notification is provided to indicate that the previously busy user is free;

FIG. 6 shows an illustrative example of SMS messages that are displayed on a graphical user interface (GUI) of a UE in accordance with the present principles;

FIG. 7 shows an illustrative GUI on a UE that may be displayed when a calling party is connected on a voice call with a previously busy user;

FIGS. 8 and 9 show illustrative GUIs that may be surfaced on a UE to enable a user to select preferences;

FIG. 10 shows an illustrative VoLTE (Voice over Long-Term Evolution) network architecture that comprises an LTE mobile network and an IMS (Internet Protocol Multimedia Subsystem) network;

FIG. 11 shows an application server (AS) arrangement in a VoLTE network that is configured to implement the present message-based notification that a called party is busy;

FIG. 12 shows an illustrative CCBS signalling flow in accordance with 3GPP TS 24.642;

FIG. 13 shows an illustrative SMS notification signalling flow in accordance with the present principles;

FIGS. 14, 15, and 16 show illustrative methods that may be performed when implementing the present message-based notification that a called party is busy;

FIG. 17 is a simplified block diagram of an illustrative computer system that may be used at least in part to implement the present message-based notification that a called party is busy; and

FIG. 18 is a block diagram of an illustrative UE that may be used at least in part to implement the present message-based notification that a called party is busy.

Like reference numerals indicate like elements in the drawings. Elements are not drawn to scale unless otherwise indicated.

### DETAILED DESCRIPTION

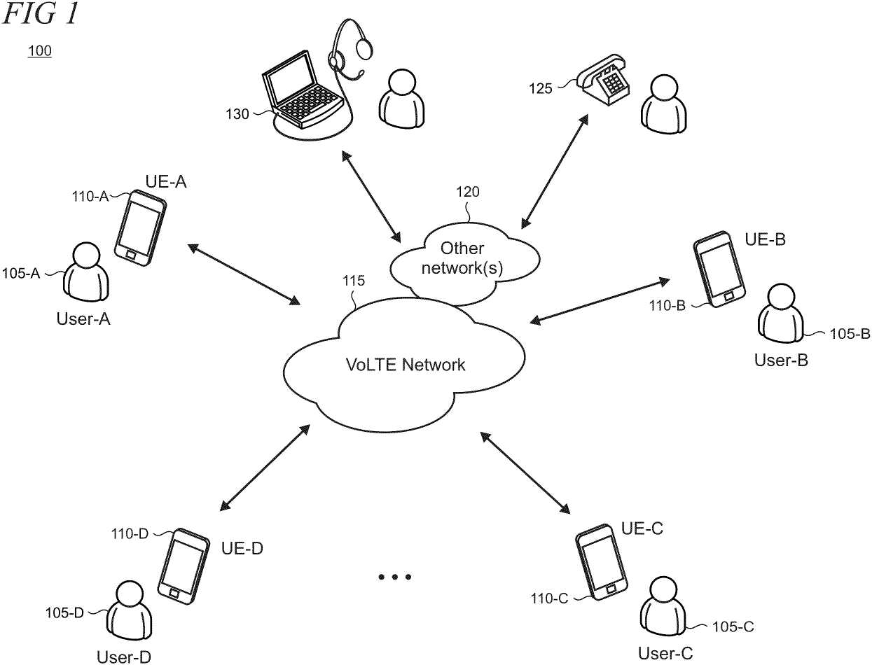

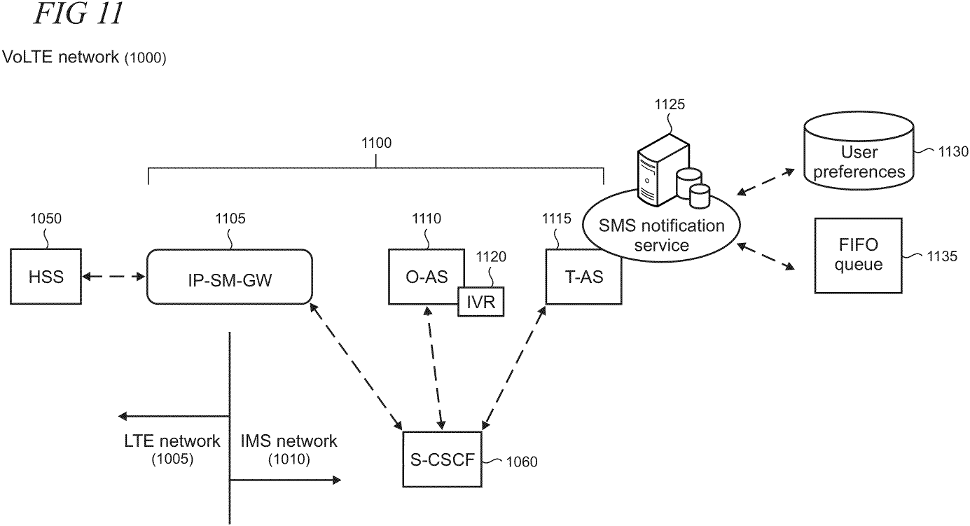

FIG. 1 shows an illustrative telecommunications environment 100 in which the same or different users 105 may employ computing devices 110 that can communicate with other computing devices and various services over a Voice over Long Term Evolution (VoLTE) mobile network 115. Technical details of the VoLTE network are described in the text below accompanying FIG. 10.

In some cases, other networks (representatively indicated by reference numeral 120) can also be supported in the telecommunications environment. The networks 115 and 120 can include different network types and network infrastructure in various combinations or sub-combinations including cellular networks, satellite networks, IP (Internet-Protocol) networks such as Wi-Fi under IEEE 802.11 and Ethernet networks under IEEE 802.3, a public switched telephone network (PSTN), and/or short-range networks such as Bluetooth® networks. The network infrastructure can be supported, for example, by mobile operators, enterprises, Internet service providers (ISPs), telephone service providers, data service providers, and the like.

Some of the users 105 and computing devices 110 may have an association such as subscription, contract, plan, or the like with one of the networks 115 and 120 (or otherwise be authorized to access and use the network), while other users and computing devices can have an association with another one of the networks. The depiction of two networks in this example is illustrative, as the number of networks utilized in the telecommunications environment can vary by implementation.

The computing devices 110 can support telephony capabilities (e.g., voice and/or video, text, or chat) and typically support data-consuming applications such as Internet browsing and multimedia (e.g., music, video, etc.) consumption in addition to various other features. The computing devices may include, for example, user equipment, mobile phones, cell phones, feature phones, tablet computers, and smartphones which users often employ to make and receive voice and/or video calls, share multimedia, engage in messaging (e.g., texting) and email communications, use applications, and access services that employ data, browse the World Wide Web, and the like. Mobile computing devices having capabilities to interact with the VoLTE network may typically be referred to as user equipment (UE).

Other types of electronic devices are also envisioned to be usable within the environment 100 including handheld computing devices, PDAs (personal digital assistants), portable media players, devices that use headsets and earphones (e.g., Bluetooth-compatible devices), phablet devices (i.e., combination smartphone/tablet devices), wearable computing devices such as head-mounted display (HMD) systems and smartwatches, navigation devices such as GPS (Global Positioning System) systems, laptop PCs (personal computers), desktop computers, multimedia consoles, gaming systems, or the like. In the discussion that follows, the use of the term “device” is intended to cover all computing devices that are configured with telephony communications capabilities and/or are otherwise enabled for IMS (Internet Protocol Multimedia Subsystem) services, as discussed in more detail below, and are capable of connectivity to one or more of the networks 115 and 120.

The various computing devices 110 in the telecommunications environment 100 can support different features, functionalities, and capabilities (here referred to generally as “features”). Some of the features supported on a given computing device can be similar to those supported on others, while other features may be unique to a given computing device. The degree of overlap and/or distinctiveness among features supported on the various computing devices can vary by implementation. For example, some computing devices can support touch controls, gesture recognition, and voice commands, while others may enable a more limited user interface. Some computing devices may support video consumption and Internet browsing, while other devices may support more limited media handling and network interface features.

Accessory devices (not shown), such as wristbands and other wearable computing devices may also be present in the telecommunications environment 100. Such accessory device is typically adapted for, but not limited to, interoperation with a coupled computing device 110 using a short-range communications protocol like Bluetooth to support functions such as monitoring of the wearer’s fitness and/or physiology (e.g., heart rate, steps taken, calories burned, etc.) and environmental conditions (temperature, humidity, ultra-violet (UV) levels, etc.), and surfacing notifications from the coupled computing device or the network directly. Some accessory devices can be configured to work on a standalone basis (i.e., without relying on a coupled computing device for functionality such as Internet connectivity) as wearable computing devices that may support an operating system and applications.

Other types of telephony equipment may also be present in the telecommunications environment 100 such as conventional desktop phones 125 which are operatively coupled to a public switched telephone network (“PSTN”). Other examples may include equipment that connects to the PSTN using private branch exchanges (“PBXs”) and equipment coupled to call services that are accessed using telephone numbers. Other types of computing devices 130, such as personal computers (PCs), laptop computers, multimedia consoles, and the like may be configured and equipped to support telephony applications in some cases.

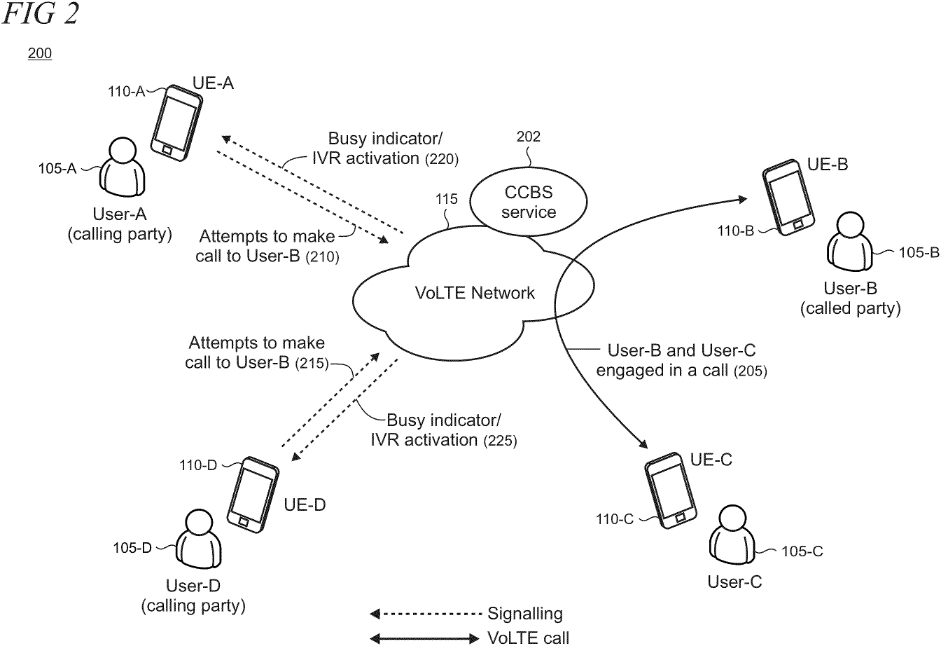

FIG. 2 shows an illustrative use scenario 200 showing a CCBS (Completion of Communications to Busy Subscriber) service 202 described by 3GPP technical specification TS 24.642. In this example, multiple users 105-A and 105-D respectively utilizing UE 110-A and 110-D attempt to make a VoLTE call over the VoLTE network 115 to a user 105-B who is busy with another voice call with a user 105-C, as indicated by reference numeral 205. As used herein, a user attempting or making a VoLTE call is referred as a “calling party” and the recipient of the attempted or made call is referred to as the “called party.” In the drawing, the call attempts are indicated by reference numerals 210 and 215. Since User-B is busy on another call, the network provides a busy indicator, respectively shown in the drawing by reference numerals 220 and 225, to each of User-A and User-D. The type of busy indicator utilized can vary by implementation and may include, for example, audio tones and/or voice.

The CCBS service is conventionally arranged to offer a call back service to the calling parties when the intended call recipient (i.e., User-B) is busy. The 3GPP technical specification provides a definition of a busy party by reference to ITU-T (International Telecommunications Union - Telecommunication) Recommendation I.221, subclause 2.1. The CCBS service activates an interactive voice response (IVR) system that is disposed in an AS in the network to communicate the call back offer to the calling parties. A calling party can accept the offer, referred to as a “CCBS activation” under TS 24.642.

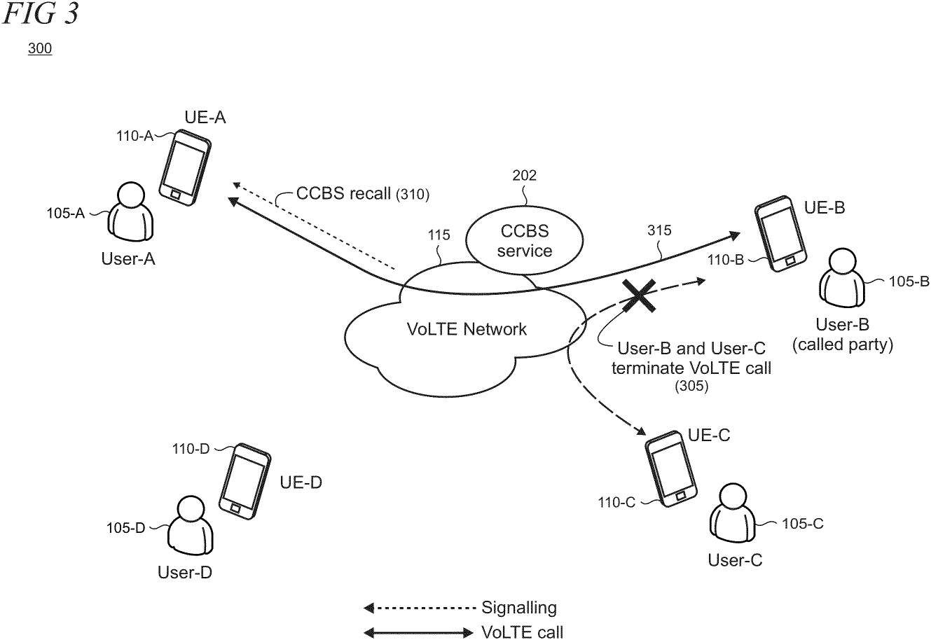

Once the service is activated by the calling party, the CCBS service 202 will monitor the call status between User-B and User-C. As shown in the use scenario 300 in FIG. 3, when that call is terminated (as indicated by reference numeral 305), a call-completion event is logged by the service. The service initiates a CCBS recall 310 to the UE 110-A. User-A can answer the recall to establish a VoLTE call 315 between the UE-A and UE-B.

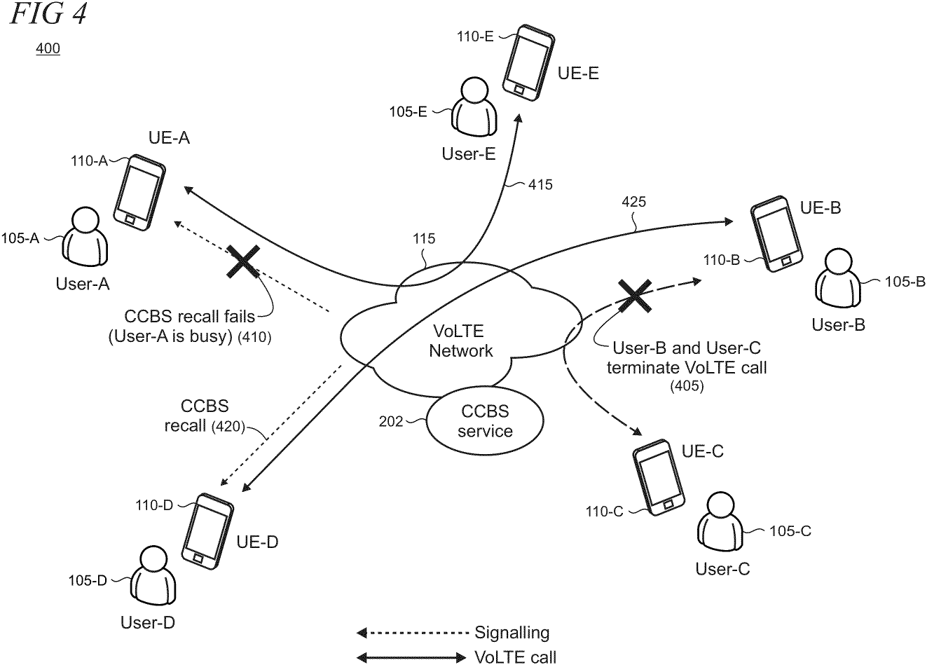

FIG. 4 shows a use scenario 400 in which the service 202 attempts a CCBS recall when the VoLTE call between User-B and User-C is terminated, as indicated by reference numeral 405. In this example, the recall attempt fails, as indicated by reference numeral 410, because User-A is busy on a call 415 with User-E. The service makes a CCBS recall 420 to User-D to thereby establish a VoLTE call 425 between the UE-D and UE-B.

In accordance with the present principles, the CCBS activation signal flow under TS 24.642 can be advantageously adapted to provide an option for the calling party to be notified by a message-based notification that the previously busy called party is now free to receive a VoLTE call. For example, rather than receive a ring and call back from the network in accordance with the conventional CCBS service offering, the calling party can be given a choice to receive an SMS message, and then opt in or out, using the IVR system.

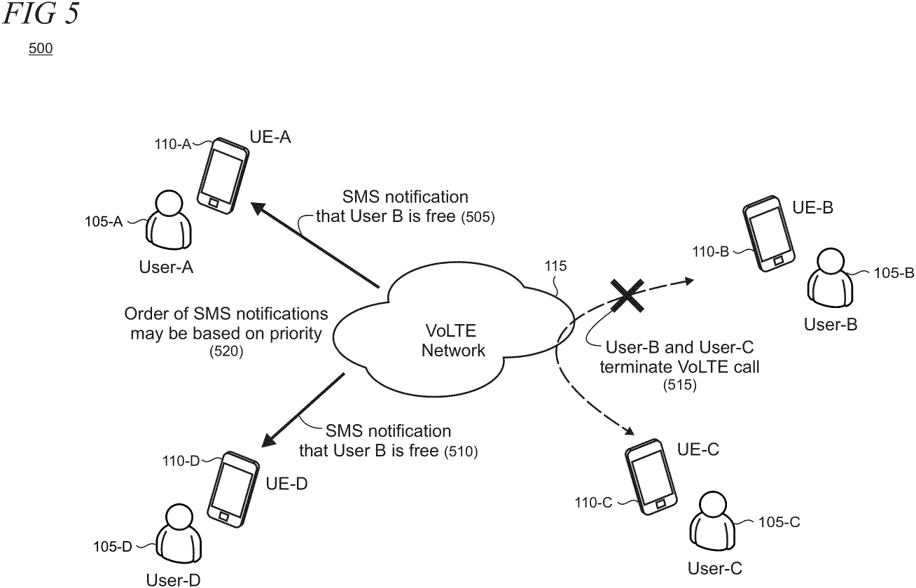

FIG. 5 shows an illustrative use scenario 500 using the present principles in which SMS messages are provided to UE-A and UE-D, as respectively indicated by reference numerals 505 and 510. The SMS messages function to notify User-A and User-D that User-B is free to receive a new VoLTE call because the call between User-B and User-C is terminated, as indicated by reference numeral 515. As indicated by reference numeral 520, the order in which the SMS notifications are provided to the calling parties can be determined by priority or by some other suitable methodology.

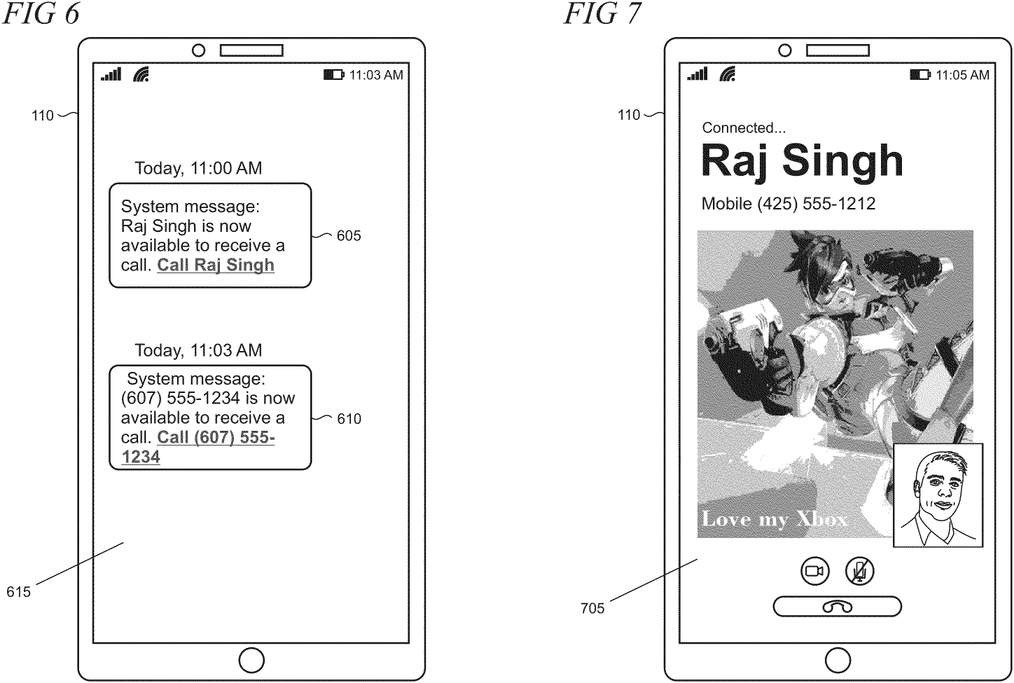

FIG. 6 shows an illustrative example of SMS messages 605 and 610 that are displayed on a graphical user interface (GUI) 615 of a UE 110 in accordance with the present principles. Both exemplary SMS messages include links or other controls configured to be actionable by a user to place a call back to a previously called and busy party. Such links may advantageously enable the calling party to initiate the call back to the called party directly from the notification without having to leave the messaging application. For example, FIG. 7 shows an illustrative GUI 705 on a UE 110 that may be launched by interaction with the actionable controls in the notification to thereby establish a voice call with a previously busy user. However, it is emphasized that such actionable controls embedded in the notifications are not required to be utilized in every implementation of the present principles.

Referring again to FIG. 6, SMS message 605 includes an identification of the called party by name while SMS message 610 includes an identification of the called party by number. Under TS 24.642, a URI (Uniform Resource Identifier) of UE-B of the called party is utilized throughout various parts of the SIP messaging in the CCBS signalling flow. Thus, an SMS notification service operating, for example, on the terminating AS (T-AS) in the network can access identifying information of the called party that may be utilized for SMS message generation. In some implementations, a messaging application on the UE of a calling party can be utilized to match the URI to a contact by name that may be stored in the user’s address book, contact list, or other suitable database.

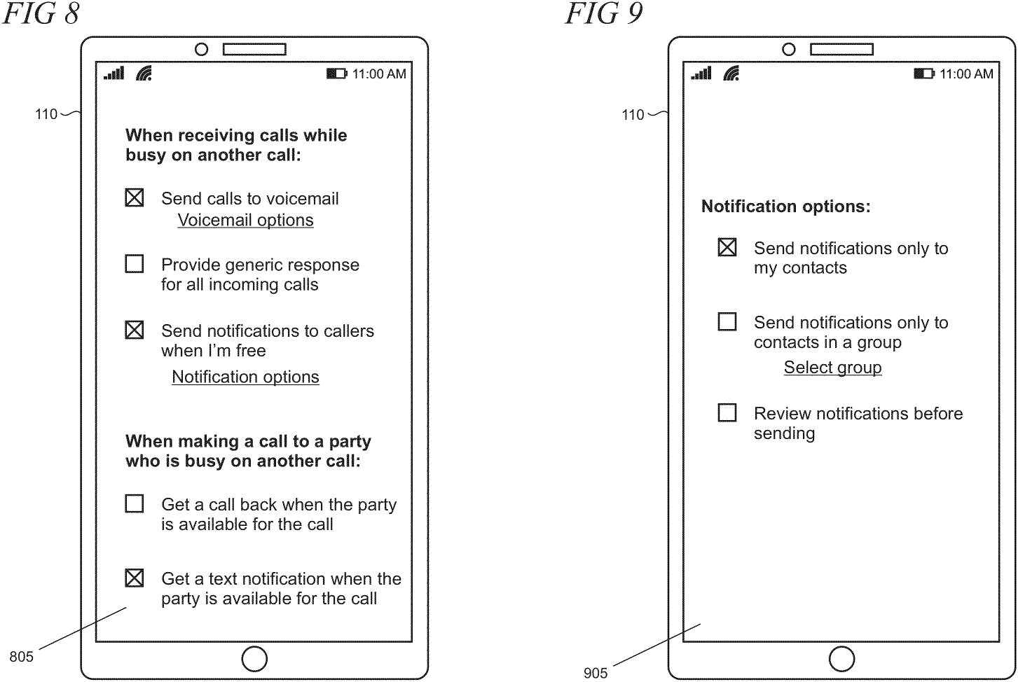

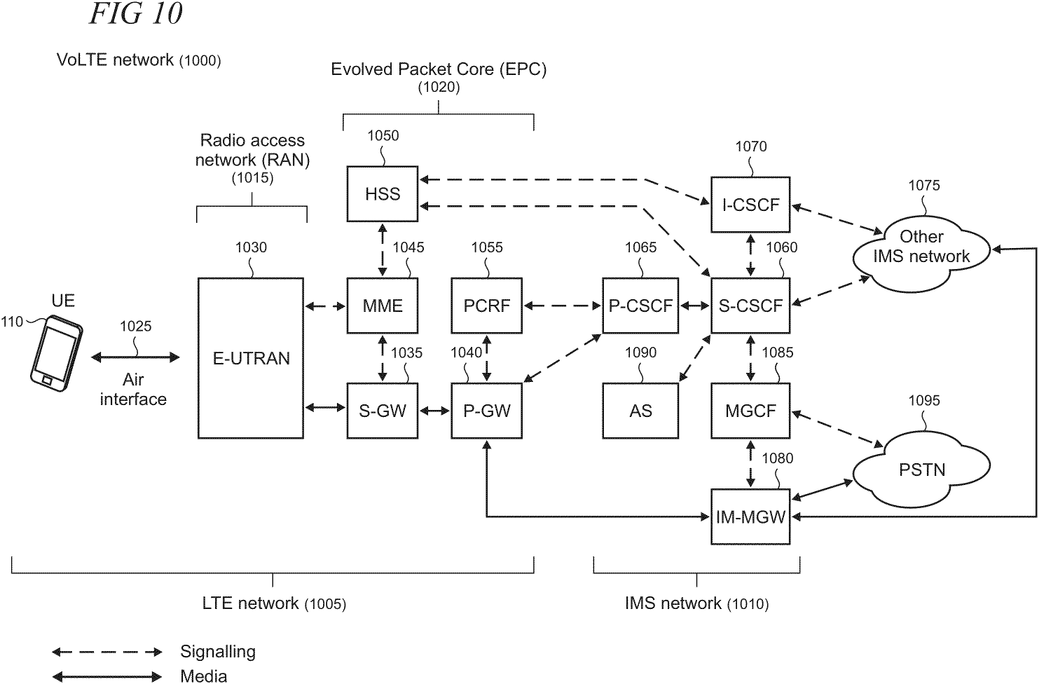

The utilization of message-based notifications as part of the CCBS service can be arranged to support a user’s selection of preferences for service behaviors. Preferences may be selected, for example, both in scenarios in which the user is a calling party and those in which the user is the called party. FIGS. 8 and 9 show illustrative GUIs that may be surfaced on a UE 110 to enable a user to select preferences. Preferences can be managed, for example, through a notification service that operates in the network 115. In some implementations, the notification service may interact with some code and/or applications that execute locally on a UE to provide user preference options and implement the preferences as part of the notification user experience.

The top portion of GUI 805 in FIG. 8 shows options to provide to a user when receiving a call while busy on another call. In this example, the user has chosen to send calls to voicemail and notify the calling parties by message when the user is free. The bottom portion of the GUI shows options provided to a user when making a call to party who is busy on another call. Here, the user can select between a conventional CCBS recall or a message-based notification in accordance with the present principles. In this example, the user has chosen to get a text notification. It may be appreciated that accommodation of such preference selections in advance may alter the IVR script described above for CCBS activation.

GUI 905 in FIG. 9 shows illustrative message-based notification options including a capability for the user to restrict notifications, provided to others, that the user is free in various ways. For example, as shown, the user can restrict the notifications to only the user’s contacts contained in a contact list or address book. Such restriction may enhance privacy and/or limit the disclosure of personally identifiable information (PII) in some use scenarios. For example, a user may desire to withhold notifications to unknown calling parties who may be sources of robocall, spam, or other unwanted calls.

FIG. 10 shows an illustrative architecture for a VoLTE network 1000 that comprises an LTE mobile network 1005 and an IMS network 1010 that may be utilized to implement telephony and supplementary services over LTE including the present message-based notification that a called party is busy. The LTE network 1005 includes a radio access network (RAN) 1015 and an Evolved Packet Core (EPC) 1020. An air interface 1025 is provided between UE 110 and an E-UTRAN (Evolved Universal Terrestrial Radio Access Network) 1030. The E-UTRAN comprises a network of eNB base stations which is responsible for handling radio communications between the UE and EPC across the air interface. An eNB controls UEs in one or more cell. LTE is a cellular system in which the eNBs provide coverage over one or more cells. Typically, there is a plurality of eNBs within an LTE system. In general, a UE in LTE communicates with one eNB through one cell at a time.

Data traffic is passed between each eNB in the E-UTRAN 1030 and a corresponding Serving Gateway (S-GW) 1035 which routes data between the eNB and a PDN (packet data network) Gateway (P-GW) 1040. The P-GW is configured for connecting UE 110 to one or more servers or PDNs (not shown) that are external to the LTE network 1005. A Mobility Management Entity (MME) 1045 controls the high-level operation of UE through signalling messages exchanged with the UE through the E-UTRAN. Each UE is registered with a single MME.

There is not a direct signalling pathway between the MME 1045 and the UE, as communication with the UE 110 is across the air interface via the E-UTRAN 1030. Signalling messages between the MME and the UE comprise EPS Session Management (ESM) protocol messages controlling the flow of data from the UE to the outside world and EPS Mobility Management (EMM) protocol messages controlling the rerouting of signalling and data flows when the UE moves between eNBs within the E-UTRAN. The MME exchanges signalling traffic with the S-GW 1035 to assist with routing data traffic. The MME also communicates with a Home Subscriber Server (HSS) 1050 which stores information about users registered with the network.

Interoperations between the LTE network 1005 and IMS network 1010 are facilitated by a PCRF (Policy and Charging Rules Function) 1055 connected to the P-GW 1040 which receives signalling messages from the LTE network requesting EPS (Evolved Packet System) bearers to carry voice calls that meet given quality of service (QoS) requirements. The IMS network includes CSCF (Call Session Control Function) servers - a serving CSCF (S-CSCF) 1060 and a proxy CSCF (P-CSCF) 1065. Each UE 110 registers with a single S-CSCF for handling voice calls, including setting up new calls and notifying the UE of received calls. The P-CSCF routes signalling between the PCRF and an appropriate S-CSCF to ensure the QoS for the LTE bearers and compresses signalling between the S-CSCF 1060 and the P-GW 1040 to reduce traffic across the LTE network. An Interrogating CSCF (I-CSCF) 1070 receives signalling messages for new calls to and from another IMS network 1075 along with further signalling between the other IMS network 1075 and IMS network 1010 passed through the S-CSCF.

An IMS Media Gateway (IM-MGW) 1080 routes voice data traffic between the P-GW 1040 in the EPC 1020 of the LTE network 1005 and other UE (not shown) connected to the same LTE network, the other IMS network 1075, or a PSTN 1095. The IM-MGW operates under the control of signalling messages received from a Media Gateway Control Function (MGCF) 1085, in turn from the S-CSCF 1060. As appropriate, the MGCF also passes signalling to the PSTN. When communicating with the PSTN, the IM-MGW 1080 converts voice call data between packet-switched data and circuit-switched data, and the MGCF similarly converts signalling messages. An AS 1090 provides the UE 110 with supplementary services such as voicemail and the present message-based notifications. In order to control call routing the S-CSCF 1060 and the I-CSCF 1070 communicate with the HSS 1050.

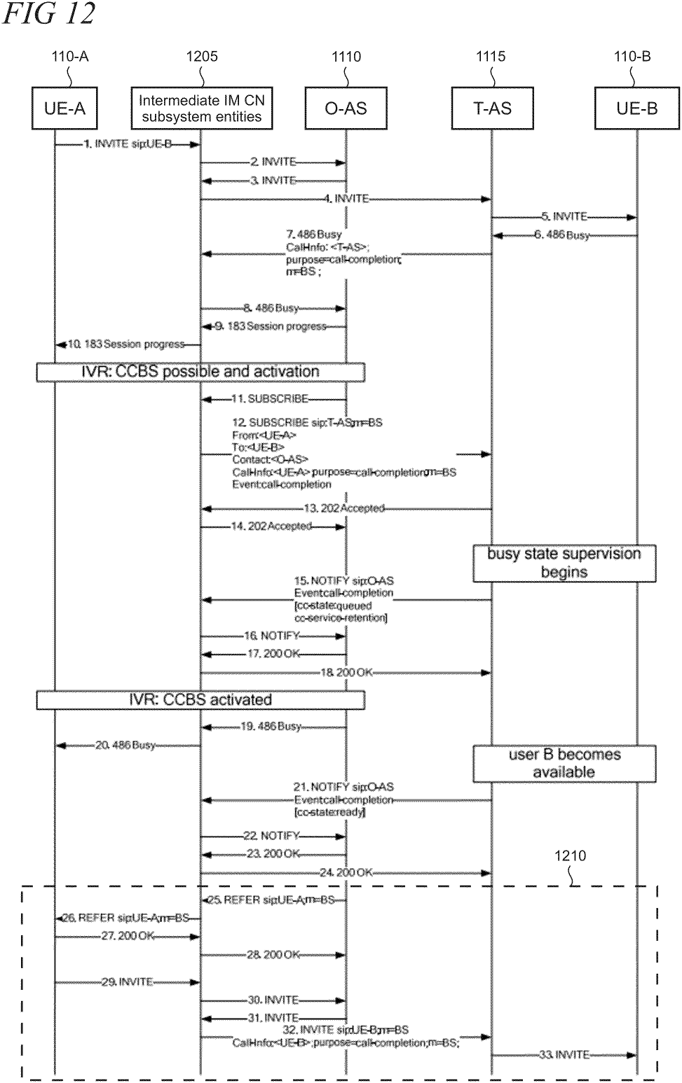

FIG. 11 shows an application server AS arrangement 1100 in the VoLTE network 1000 that is configured to implement the present message-based notification that a called party is busy. SMS messaging in VoLTE networks may be handled by a gateway device located between the LTE network 1005 and IMS network 1010 - an IP (Internet Protocol) Short-Message-Gateway (IP-SM-GW) 1105 that is coupled to receive SIP signalling from the HSS 1050 and S-CSCF 1060, as shown. From the perspective of the IMS network and S-CSCF, the IM-SM-GW appears as another AS.

The AS arrangement further includes an originating AS (O-AS) 1110 and a terminating AS (T-AS) 1115. Among other supported functionalities, the O-AS includes an IVR system 1120 and the T-AS includes an SMS notification service 1125 arranged in accordance with the present principles. The SMS notification service interoperates with a database 1130 storing user preferences (described above in the text accompanying FIGS. 8 and 9) and a FIFO queue 1135. For example, the FIFO queue can be used to store timestamp information pertaining to multiple calling parties who attempt to call a user who is busy on another call. When the caller becomes free, the SMS notifications can be sent to the calling parties based on FIFO order. In alternative implementations, other prioritization schemes may be utilized to determine an order for the notifications in which some calling parties are given higher priority than others and will be notified first. For example, a user may wish that a friend or family member is notified before a work colleague. Such prioritization may be established by user selection and/or predefined user preferences.

The SMS notification service 1125 implements a CCBS signalling flow as described in Annex A.1 “CCBS activation and CCBS call” of 3GPP TS 24.642 version 16.0.0 Release 16 that is advantageously modified to provide the present message-based notification that a called party is busy.

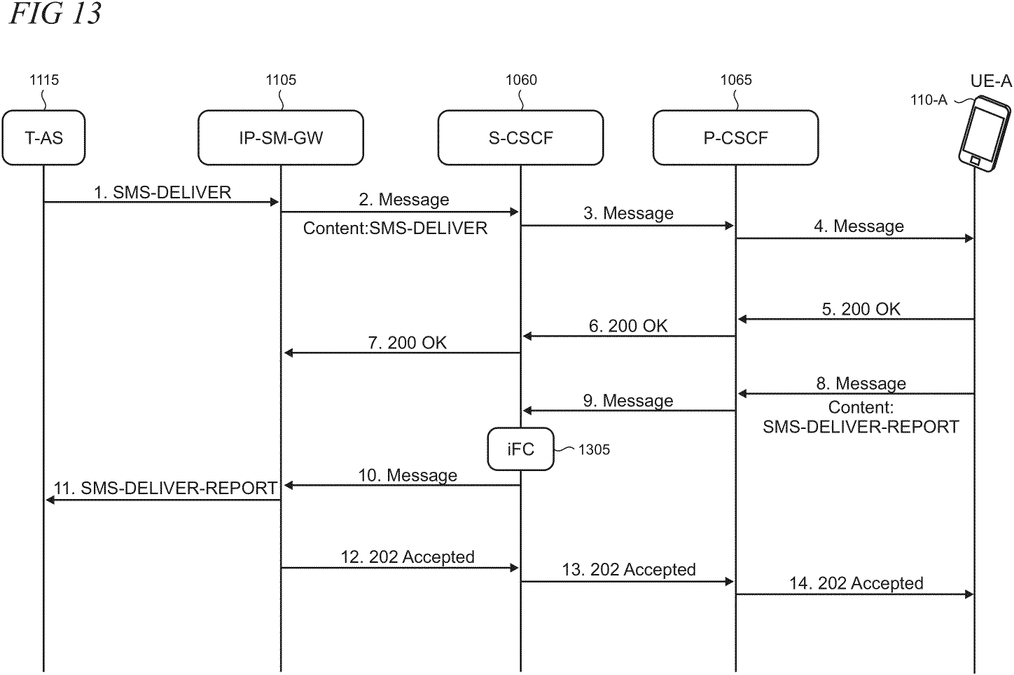

FIG. 12 shows signals in an illustrative CCBS signalling flow described in Annex A.1 of 3GPP TS 24.642. The intermediate IM (IP Multimedia) and CN (Core Network) subsystem entities 1205 may include, for example the CSCF servers. With signals 1 to 5, the communication is initiated by UE-A by sending an INVITE request. The Request-URI will include the URI of UE-B. After iFC (Initial Filter Criteria) evaluation in the S-CSCF, the INVITE request is routed to the originating AS and after that to the terminating AS and further on to UE-B. With signal 6, UE-B answers with a 486 (Busy Here) response. The 486 (Busy Here) response is routed back to the T-AS.

With signals 7 and 8, the T-AS inserts a Call-Info header field in the 486 (Busy Here) response according to the procedures described in RFC 6910 “Completion of Calls for the Session Initiation Protocol (SIP)” (April 2013). The Call-Info header field will contain the URI of the terminating AS with an “m” header field parameter set to “BS” (busy subscriber). It further includes a “purpose” header field parameter set to “call-completion”. The 486 (Busy Here) response is routed back to the O-AS.

With signals 9 and 10, the O-AS sends back a 183 (Session Progress) response to UE-A and initiates IVR procedures. User-A is informed that CCBS is possible. User-A activates CCBS. With signals 11 and 12, the originating AS subscribes for the call-completion event package according to the procedures described in RFC 6910 at the T-AS. The O-AS generates a SUBSCRIBE request in which the Request-URI will include the URI of the T-AS. In order to mark the SUBSCRIBE request as a request for CCBS, the O-AS adds the “m” SIP URI parameter with the value “BS” to the Request-URI. The From header field will include the caller URI. The To header field will include the callee URI.

With signals 13 and 14, the T-AS accepts the subscription and starts busy state supervision procedures on the called party. With signals 15to 18, the T-AS sends a notification to the O-AS, according to the procedures described in RFC 6910. The Request-URI of the NOTIFY request will include the URI of the O-AS. The body contains parameters informing of the caller’s call-completion state ‘queued’ and the availability of the call-completion service retention at the T-AS. After confirmation of the notification, the O-AS starts announcement procedures informing about the activation of CCBS.

With signals 19 and 20, the O-AS forwards the 486 (Busy Here) response to UE-A. With signals 21 to 24, the T-AS sends a NOTIFY request to the O-AS, according to the procedures described in RFC 6910. The body contains a parameter informing of the caller’s call-completion state ‘ready’ (for recall). The O-AS confirms the notification. The remaining signals 25 to 33 are replaced by a different signalling flow, as shown by the dashed rectangle and reference numeral 1210 in FIG. 12 to implement the present message-based notifications that a called party is busy. The replacement/modified signalling flow is shown in FIG. 13 and described in the accompanying text below.

FIG. 13 shows an illustrative SMS notification signalling flow in accordance with the present principles. With signals 1 to 4, in response to the confirmation from the S-CSCF (signal 24 in FIG. 12), the SMS notification service operating on the T-AS 1115 generates an SMS DELIVER short message transfer protocol data unit (PDU) that includes the user data for the notification to UE-A (and User-A) that User-B is now free to receive a new VoLTE call. The SMS message is relayed through the IP-SM-GW 1105, S-CSCF 1060, and P-CSCF 1065 to the UE-A, as shown. With signals 5 to 7, a message acknowledgement, 200 OK, is routed back to the IP-SM-GW.

With signals 8 to 10, the UE-A provides an SMS-DELIVER-REPORT PDU that can provide a failure cause (if necessary, as appropriate), or information as part of a positive or negative acknowledgement of the SMS-DELIVER PDU which may be subject to iFC evaluation, as indicated by reference numeral 1305. The elements of SMS-DELIVER-REPORT are described in 3GPP TS 23.040. The IP-SM-GW 1105 forwards the report to the T-AS with signal 11 and provides a SIP 202 Accepted message that is routed to the UE-A with signals 12 to 14.

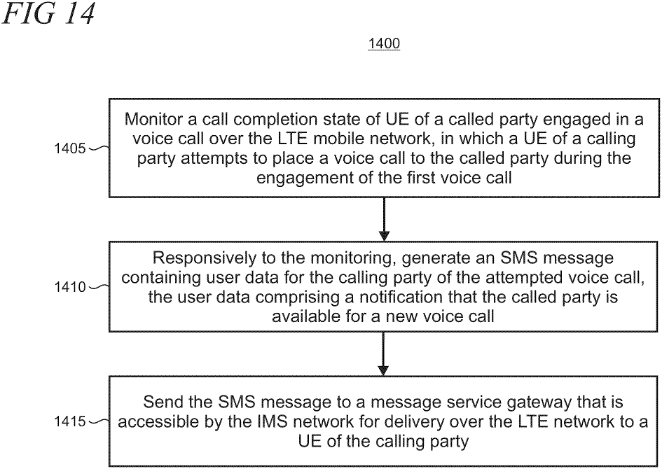

FIG. 14 is a flowchart of an illustrative method 1400 that may be performed by an AS in an IMS network that is configured for interoperations with an LTE mobile network. Unless specifically stated, methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

Block 1405 includes monitoring a call completion state of UE of a called party engaged in a voice call over the LTE mobile network, in which a UE of a calling party attempts to place a voice call to the called party during the engagement of the first voice call. Block 1410 includes, responsively to the monitoring, generating an SMS message containing user data for the calling party of the attempted voice call, the user data comprising a notification that the called party is available for a new voice call. Block 1415 includes sending the SMS message to a message service gateway that is accessible by the IMS network for delivery over the LTE network to a UE of the calling party.

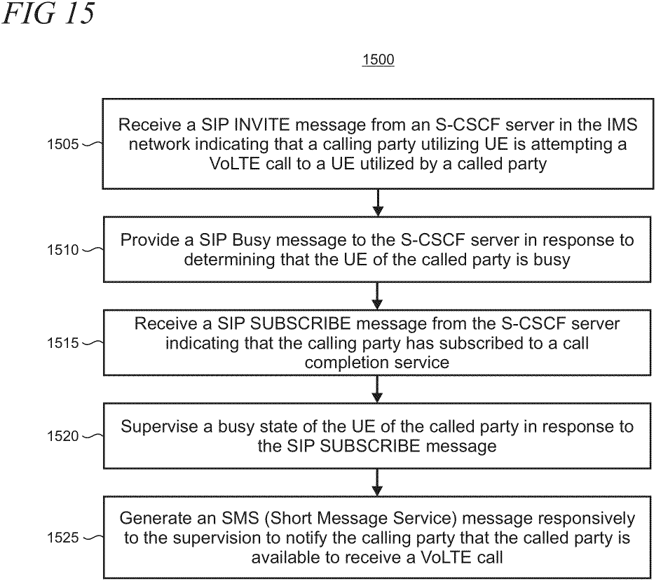

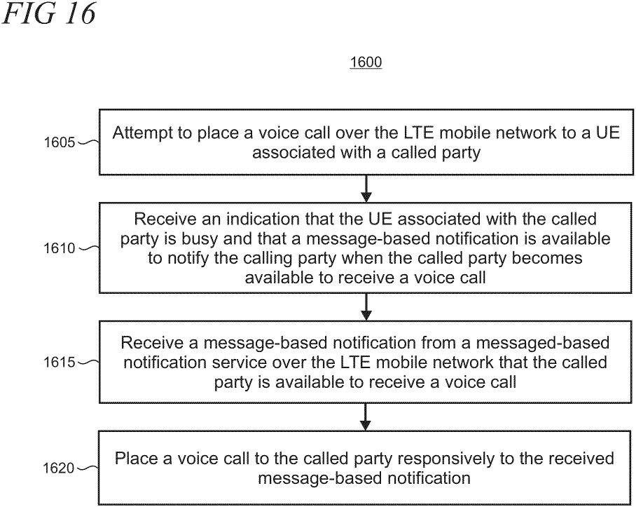

FIG. 15 is a flowchart of an illustrative method 1500 that may be performed by a computing device, for example an AS, deployed in an IMS network configured for interoperations with an LTE mobile network. Block 1505 includes receiving a SIP INVITE message from an S-CSCF server in the IMS network indicating that a calling party utilizing UE is attempting a VoLTE call to a UE utilized by a called party. Block 1510 includes providing a SIP Busy message to the S-CSCF server in response to determining that the UE of the called party is busy.

Block 1515 includes receiving a SIP SUBSCRIBE message from the S-CSCF server indicating that the calling party has subscribed to a call completion service. Block 1520 includes supervising a busy state of the UE of the called party in response to the SIP SUBSCRIBE message. Block 1525 includes generating an SMS message responsively to the supervision to notify the calling party that the called party is available to receive a VoLTE call.

FIG. 16 is a flowchart of an illustrative method 1600 that may be performed by a computing device that is configured as UE. Block 1605 includes attempting to place a voice call over the LTE mobile network to a UE associated with a called party, Block 1610 includes receiving an indication that the UE associated with the called party is busy and that a message-based notification is available to notify the calling party when the called party becomes available to receive a voice call.

Block 1615 includes receiving a message-based notification from a messaged-based notification service over the LTE mobile network that the called party is available to receive a voice call. Block 1620 includes placing a voice call to the called party responsively to the received message-based notification.

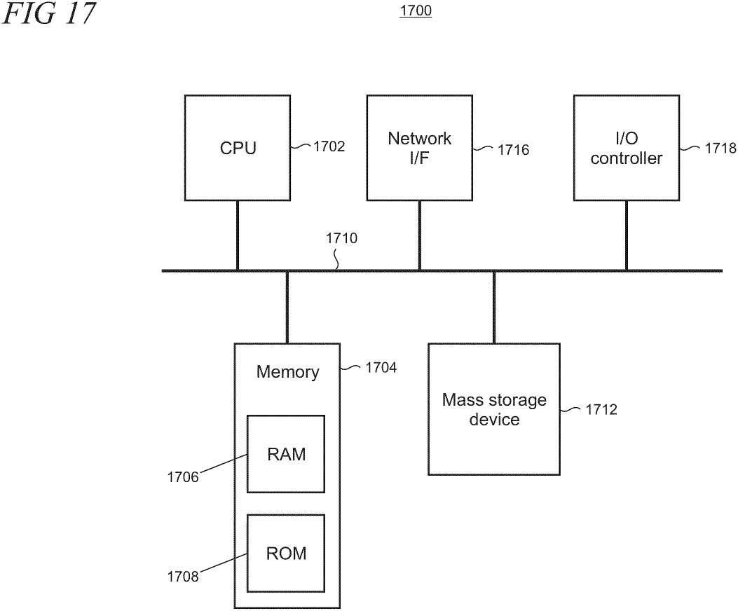

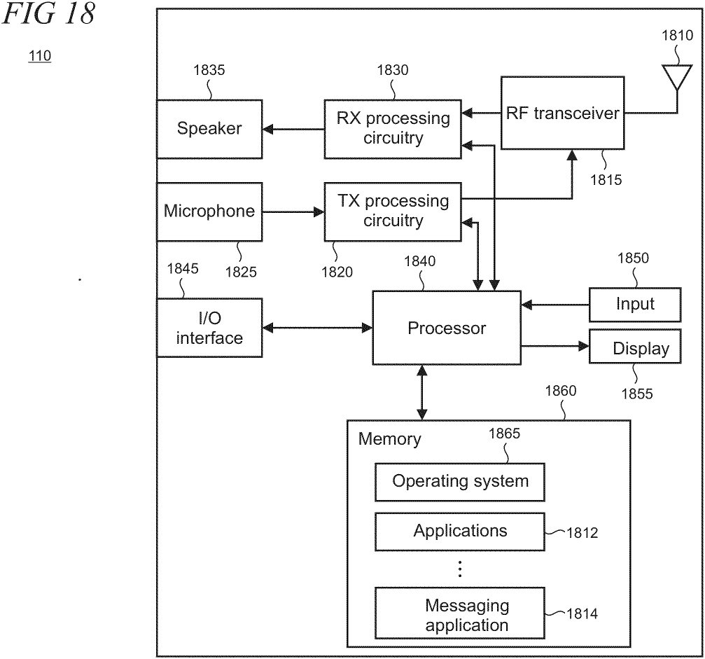

FIG. 17 shows an illustrative architecture 1700 for a computing device, such as a server, capable of executing the various components described herein for message-based notifications. The architecture 1700 illustrated in FIG. 17 includes one or more processors 1702 (e.g., central processing unit, dedicated AI chip, graphics processing unit, etc.), a system memory 1704, including RAM (random access memory) 1706 and ROM (read only memory) 1708, and a system bus 1710 that operatively and functionally couples the components in the architecture 1700. A basic input/output system containing the basic routines that help to transfer information between elements within the architecture 1700, such as during startup, is typically stored in the ROM 1708. The architecture 1700 further includes a mass storage device 1712 for storing software code or other computer-executed code that is utilized to implement applications, the file system, and the operating system. The mass storage device 1712 is connected to the processor 1702 through a mass storage controller (not shown) connected to the bus 1710. The mass storage device 1712 and its associated computer-readable storage media provide non-volatile storage for the architecture 1700. Although the description of computer-readable storage media contained herein refers to a mass storage device, such as a hard disk or CD-ROM drive, it may be appreciated by those skilled in the art that computer-readable storage media can be any available storage media that can be accessed by the architecture 1700.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1700.

According to various embodiments, the architecture 1700 may operate in a networked environment using logical connections to remote computers through a network. The architecture 1700 may connect to the network through a network interface unit 1716 connected to the bus 1710. It may be appreciated that the network interface unit 1716 also may be utilized to connect to other types of networks and remote computer systems. The architecture 1700 also may include an input/output controller 1718 for receiving and processing input from a number of other devices, including a keyboard, mouse, touchpad, touchscreen, control devices such as buttons and switches or electronic stylus (not shown in FIG. 17). Similarly, the input/output controller 1718 may provide output to a display screen, user interface, a printer, or other type of output device (also not shown in FIG. 17).

It may be appreciated that the software components described herein may, when loaded into the processor 1702 and executed, transform the processor 1702 and the overall architecture 1700 from a general-purpose computing system into a special-purpose computing system customized to facilitate the functionality presented herein. The processor 1702 may be constructed from any number of transistors or other discrete circuit elements, which may individually or collectively assume any number of states. More specifically, the processor 1702 may operate as a finite-state machine, in response to executable instructions contained within the software modules disclosed herein. These computer-executable instructions may transform the processor 1702 by specifying how the processor 1702 transitions between states, thereby transforming the transistors or other discrete hardware elements constituting the processor 1702.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 1700 in order to store and execute the software components presented herein. It also may be appreciated that the architecture 1700 may include other types of computing devices, including wearable devices, handheld computers, embedded computer systems, smartphones, PDAs, and other types of computing devices known to those skilled in the art. It is also contemplated that the architecture 1700 may not include all of the components shown in FIG. 17, may include other components that are not explicitly shown in FIG. 17, or may utilize an architecture completely different from that shown in FIG. 17.

FIG. 18 is a block diagram of an illustrative UE 110 that may be used at least in part to implement the present message-based notification that a called party is busy. The embodiment of the UE 110 shown in FIG. 18 is for illustration only, and the UEs shown in the drawings and described in the preceding text may have the same or similar configuration. However, it is noted that UEs may come in a wide variety of configurations, and FIG. 18 does not limit the scope of the present disclosure to any particular implementation of a UE.

The UE 110 includes an antenna 1810, a radio frequency (RF) transceiver 1815, transmit (TX) processing circuitry 1820, a microphone 1825, and receive (RX) processing circuitry 1830. The UE 110 also includes a speaker 1835, a processor 1840, an input/output (I/O) interface 1845, an input device 1850, a display 1855, and a memory 1860. The memory includes an operating system (OS) program 1865 and one or more applications 1812. A messaging application 1814, for example, may be included as one of the applications 1812.

The RF transceiver 1815 receives from the antenna 1810, an incoming RF signal transmitted by a gNB of a 5G network 400 (FIG. 4). The RF transceiver down-converts the incoming RF signal to generate an intermediate frequency (IF) or baseband signal. The IF or baseband signal is sent to the RX processing circuitry 1830, which generates a processed baseband signal by filtering, decoding, and/or digitizing the baseband or IF signal. The RX processing circuitry transmits the processed baseband signal to the speaker 1835 (such as for voice data) or to the processor 1840 for further processing (such as for web browsing data).

The TX processing circuitry 1820 receives analog or digital voice data from the microphone 1825 or other outgoing baseband data (such as web data, e-mail, or interactive video game data) from the processor 1840. The TX processing circuitry 1820 encodes, multiplexes, and/or digitizes the outgoing baseband data to generate a processed baseband or IF signal. The RF transceiver 1815 receives the outgoing processed baseband or IF signal from the TX processing circuitry and up-converts the baseband or IF signal to an RF signal that is transmitted via the antenna.

The processor 1840 can include one or more processors or other processing devices and execute the OS program 1865 stored in the memory 1860 to control the overall operation of the UE 110. For example, the processor may control the reception of forward channel signals and the transmission of reverse channel signals by the RF transceiver 1815, the RX processing circuitry 1830, and the TX processing circuitry 1820 in accordance with well-known principles. In some embodiments, the processor 1840 includes at least one microprocessor or microcontroller.

The processor 1840 may be configured for executing other processes and programs resident in the memory 1860, such as operations for CSI measurement and reporting for systems described in embodiments of the present disclosure. The processor can move data into or out of the memory as required by an executing process. In some embodiments, the processor may be configured to execute the applications 1812 based on the OS program 1865 or in response to signals received from gNBs or an operator. The processor is also coupled to the I/O interface 1845, which provides the UE 110 with the ability to connect to other computing devices such as laptop computers and handheld computers. The I/O interface may thus function as a communication path between such accessories and the processor.

The processor 1840 is also coupled to the input device 1850 (e.g., keypad, touchscreen, buttons etc.) and the display 1855. A user of the UE 110 can typically employ the input device to enter data into the UE. For example, the display can be a liquid crystal display or other display capable of rendering text and/or graphics, video, etc., from web sites, applications and/or service providers.

The memory 1860 is coupled to the processor 1840. Part of the memory may include a random access memory (RAM), and another part of the memory may include a Flash memory or other read-only memory (ROM).

As described in more detail below, the UE 110 can perform signalling and calculation for channel state information (CSI) reporting. Although FIG. 18 shows one illustrative example of UE 110, it may be appreciated that various changes may be made to the drawing. For example, various components may be combined, further subdivided, or omitted, and additional components may be added according to particular needs. As a particular example, the processor 1840 may be divided into multiple processors, such as one or more central processing units (CPUs) and one or more graphics processing units (GPUs). Also, while FIG. 18 depicts the UE 110 as configured as a mobile device, such as a smartphone, UEs may be configured to operate as other types of portable or stationary devices.

Various exemplary embodiments of the present message-based notification that a called party is busy are now presented by way of illustration and not as an exhaustive list of all embodiments. An example includes a computer-implemented method performed by an application server (AS) in an IMS (Internet Protocol Multimedia Subsystem) network configured for interoperations with an LTE (Long-Term Evolution) mobile network, the method comprising: monitoring a call completion state of user equipment (UE) of a called party engaged in a voice call over the LTE mobile network, in which a UE of a calling party attempts to place a voice call to the called party during the engagement of the first voice call; responsively to the monitoring, generating an SMS (Short Message Service) message containing user data for the calling party of the attempted voice call, the user data comprising a notification that the called party is available for a new voice call; and sending the SMS message to a message service gateway that is accessible by the IMS network for delivery over the LTE network to a UE of the calling party.

In another example, the computer-implemented method further comprises receiving a SIP (Session Initiation Protocol) message by the AS from a S-CSCF (Serving Call Session Control Function) server in the IMS network server indicating that, for the attempted voice call, the calling party has subscribed to a Completion of Communications to Busy Subscriber (CCBS) service described by 3GPP (3rd Generation Partnership Project) TS 24.642. In another example, the AS is a terminating AS (T-AS). In another example, the message service gateway comprises an IP (Internet Protocol) Short-Message-Gateway (IP-SM-GW) as defined by 3GPP (3rd Generation Partnership Project) TS 23.040. In another example, the IP-SM-GW is configured to operate as an AS in the IMS network. In another example, the computer-implemented method further comprises receiving a URI (uniform resource identifier) for the UE of the called party from the S-CSCF server. In another example, the computer-implemented method further includes incorporating the URI into the user data and configuring the URI to be actionable by the calling party in the SMS message to initiate a voice call back to the called party. In another example, the computer-implemented method further includes tracking instances in which multiple calling parties attempt to reach the called party while the called party is busy on a voice call, queuing SMS-based notifications for the multiple calling parties, and sending the SMS-based notifications to the message service gateway from the queue in a predetermined order. In another example, the queue comprises a FIFO (first in, first out) queue. In another example, the called party is unavailable by being busy as defined by ITU-T (International Telecommunications Union - Telecommunication) Recommendation I.221, subclause 2.1.

A further example includes one or more hardware-based non-transitory computer-readable memory devices storing computer-executable instructions which, upon execution by one or more processors disposed in a computing device deployed in an IMS (Internet Protocol Multimedia Subsystem) network configured for interoperations with an LTE (Long-Term Evolution) mobile network, cause the computing device to: receive a SIP (Session Initiation Protocol) INVITE message from a serving call session control function (S-CSCF) server in the IMS network indicating that a calling party utilizing user equipment (UE) is attempting a voice over LTE (VoLTE) call to a UE utilized by a called party; provide a SIP Busy message to the S-CSCF server in response to determining that the UE of the called party is busy; receive a SIP SUBSCRIBE message from the S-CSCF server indicating that the calling party has subscribed to a call completion service; supervise a busy state of the UE of the called party in response to the SIP SUBSCRIBE message; and generate an SMS (Short Message Service) message responsively to the supervision to notify the calling party that the called party is available to receive a VoLTE call.

In another example, the call completion service comprises a CCBS (Completion of Communications to Busy Subscriber) service in accordance with 3GPP (3rd Generation Partnership Project) TS 24.642. In another example, the executed instructions further cause the computing device to send the SMS message to an IP (Internet Protocol) Short-Message-Gateway (IP-SM-GW), wherein the IP-SM-GW is configured to relay the SMS message to the UE of the calling party using the LTE mobile network. In another example, the executed instructions further cause the computing device to generate the SMS message to include a user-accessible link to initiate a call back to the called party, the link providing an identification of the called party matching a stored contact of the calling party. In another example, the executed instructions further cause the computing device to send a SIP NOTIFY message to the S-CSCF server responsively to the supervision indicating that the UE of the called party is available to receive a VoLTE call, wherein the S-CSCF server uses the SIP NOTIFY message to initiate a CCBS (Completion of Communications to Busy Subscriber) service interaction using an interactive voice response (IVR) system with the UE of the calling party.

A further example includes a computing device configured as user equipment (UE) associated with a calling party, the UE arranged for accessing an LTE (Long-Term Evolution) mobile network, comprising: at least one processor; a user interface (UI); and at least one hardware-based non-transitory computer-readable storage device having computer-executable instructions stored thereon which, when executed by the at least one processor, cause the computing device to attempt to place a voice call over the LTE mobile network to a UE associated with a called party; receive an indication that the UE associated with the called party is busy on another voice call and that a message-based notification is available to notify the calling party when the called party is no longer busy and becomes available to receive a voice call; receive a message-based notification from a messaged-based notification service over the LTE mobile network that the called party is available to receive a voice call; and place a voice call to the called party responsively to the received message-based notification.

In another example, the indication is provided by an interactive voice response (IVR) system. In another example, the executed instructions further cause the computing device to provide an activation of the message-based notification service responsively to an input at the UI from the calling party. In another example, the executed instructions further cause the computing device to surface options on the UI for selecting preferences for the message-based notification service, the preferences including service actions for sending and receiving message-based notifications. In another example, the executed instructions further cause the computing device to display the message-based notification in a messaging application that executes on the computing device on the UI, wherein the displayed message-based notification includes a user-selectable control to initiate a call back to the called party.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method performed by an application server (AS) in an IMS (Internet Protocol Multimedia Subsystem) network configured for interoperations with an LTE (Long-Term Evolution) mobile network, the method comprising:
monitoring a call completion state of user equipment (UE) of a called party engaged in a voice call over the LTE mobile network, in which a UE of a calling party attempts to place a voice call to the called party during the engagement of the first voice call;
responsively to the monitoring, generating an SMS (Short Message Service) message containing user data for the calling party of the attempted voice call, the user data comprising a notification that the called party is available for a new voice call; and
sending the SMS message to a message service gateway that is accessible by the IMS network for delivery over the LTE network to a UE of the calling party.

2. The computer-implemented method of claim 1 further comprising receiving a SIP (Session Initiation Protocol) message by the AS from a S-CSCF (Serving Call Session Control Function) server in the IMS network server indicating that, for the attempted voice call, the calling party has subscribed to a Completion of Communications to Busy Subscriber (CCBS) service described by 3GPP (3rd Generation Partnership Project) TS 24.642.

3. The computer-implemented method of claim 1 in which the AS is a terminating AS (T-AS).

4. The computer-implemented method of claim 1 in which the message service gateway comprises an IP (Internet Protocol) Short-Message-Gateway (IP-SM-GW) as defined by 3GPP (3rd Generation Partnership Project) TS 23.040.

5. The computer-implemented method of claim 4 in which the IP-SM-GW is configured to operate as an AS in the IMS network.

6. The computer-implemented method of claim 2 further comprising receiving a URI (uniform resource identifier) for the UE of the called party from the S-CSCF server.

7. The computer-implemented method of claim 6 further including incorporating the URI into the user data and configuring the URI to be actionable by the calling party in the SMS message to initiate a voice call back to the called party.

8. The computer-implemented method of claim 1 further including tracking instances in which multiple calling parties attempt to reach the called party while the called party is busy on a voice call, queuing SMS-based notifications for the multiple calling parties, and sending the SMS-based notifications to the message service gateway from the queue in a predetermined order.

9. The computer-implemented method of claim 1 in which the queue comprises a FIFO (first in, first out) queue.

10. The computer-implemented method of claim 1 in which the called party is unavailable by being busy as defined by ITU-T (International Telecommunications Union - Telecommunication) Recommendation I.221, subclause 2.1.

11. One or more hardware-based non-transitory computer-readable memory devices storing computer-executable instructions which, upon execution by one or more processors disposed in a computing device deployed in an IMS (Internet Protocol Multimedia Subsystem) network configured for interoperations with an LTE (Long-Term Evolution) mobile network, cause the computing device to:
receive a SIP (Session Initiation Protocol) INVITE message from a serving call session control function (S-CSCF) server in the IMS network indicating that a calling party utilizing user equipment (UE) is attempting a voice over LTE (VoLTE) call to a UE utilized by a called party;
provide a SIP Busy message to the S-CSCF server in response to determining that the UE of the called party is busy;
receive a SIP SUBSCRIBE message from the S-CSCF server indicating that the calling party has subscribed to a call completion service;
supervise a busy state of the UE of the called party in response to the SIP SUBSCRIBE message; and
generate an SMS (Short Message Service) message responsively to the supervision to notify the calling party that the called party is available to receive a VoLTE call.

12. The one or more hardware-based non-transitory computer-readable memory devices of claim 11 in which the call completion service comprises a CCBS (Completion of Communications to Busy Subscriber) service in accordance with 3GPP (3rd Generation Partnership Project) TS 24.642.

13. The one or more hardware-based non-transitory computer-readable memory devices of claim 11 in which the executed instructions further cause the computing device to send the SMS message to an IP (Internet Protocol) Short-Message-Gateway (IP-SM-GW), wherein the IP-SM-GW is configured to relay the SMS message to the UE of the calling party using the LTE mobile network.

14. The one or more hardware-based non-transitory computer-readable memory devices of claim 11 in which the executed instructions further cause the computing device to generate the SMS message to include a user-accessible link to initiate a call back to the called party, the link providing an identification of the called party matching a stored contact of the calling party.

15. The one or more hardware-based non-transitory computer-readable memory devices of claim 11 in which the executed instructions further cause the computing device to send a SIP NOTIFY message to the S-CSCF server responsively to the supervision indicating that the UE of the called party is available to receive a VoLTE call, wherein the S-CSCF server uses the SIP NOTIFY message to initiate a CCBS (Completion of Communications to Busy Subscriber) service interaction using an interactive voice response (IVR) system with the UE of the calling party.

16. A computing device configured as user equipment (UE) associated with a calling party, the UE arranged for accessing an LTE (Long-Term Evolution) mobile network, comprising:
at least one processor;
a user interface (UI); and
at least one hardware-based non-transitory computer-readable storage device having computer-executable instructions stored thereon which, when executed by the at least one processor, cause the computing device to
attempt to place a voice call over the LTE mobile network to a UE associated with a called party;
receive an indication that the UE associated with the called party is busy on another voice call and that a message-based notification is available to notify the calling party when the called party is no longer busy and becomes available to receive a voice call;
receive a message-based notification from a messaged-based notification service over the LTE mobile network that the called party is available to receive a voice call; and
place a voice call to the called party responsively to the received message-based notification.

17. The computing device of claim 16 in which the indication is provided by an interactive voice response (IVR) system.

18. The computing device of claim 17 in which the executed instructions further cause the computing device to provide an activation of the message-based notification service responsively to an input at the UI from the calling party.

19. The computing device of claim 17 in which the executed instructions further cause the computing device to surface options on the UI for selecting preferences for the message-based notification service, the preferences including service actions for sending and receiving message-based notifications.

20. The computing device of claim 17 in which the executed instructions further cause the computing device to display the message-based notification in a messaging application that executes on the computing device on the UI, wherein the displayed message-based notification includes a user-selectable control to initiate a call back to the called party.
